(19) United States
(12) Patent Application Publication
(10) Pub. No.: US 2026/0078062 A1
(43) Pub. Date: Mar. 19, 2026

(54) NICKEL-ZINC FERRITE MATERIAL, AND PREPARATION METHOD THEREFOR AND USE THEREOF

(71) Applicant: HENGDIAN GROUP DMEGC MAGNETICS CO., LTD, Dongyang City Jinhua, Zhejiang (CN)

(72) Inventors: Junlin CHEN, Dongyang City Jinhua, Zhejiang (CN); Likang ZHANG, Dongyang City Jinhua, Zhejiang (CN)

(21) Appl. No.: 19/109,546

(22) PCT Filed: Nov. 14, 2023
(86) PCT No.: PCT/CN2023/131446

§ 371 Date: Mar. 6, 2025

(30) Foreign Application Priority Data
Nov. 17, 2022 (CN) 202211458597.5

(51) Int. Cl. C04B 35/26; C04B 35/626; C04B 35/634; C04B 35/64; H01F 1/34

(52) U.S. Cl. CPC C04B 35/2608; C04B 35/6261; C04B 35/62675; C04B 35/62695; C04B 35/63416; C04B 35/64; H01F 1/344; C04B 2235/3224; C04B 2235/3232; C04B 2235/3251; C04B 2235/3263; C04B 2235/3274; C04B 2235/3275; C04B 2235/3279; C04B 2235/3281; C04B 2235/3284; C04B 2235/604; C04B 2235/608; C04B 2235/6567

(57) ABSTRACT

Provided in the present application are a nickel-zinc ferrite material, and a preparation method therefor and the use thereof. The nickel-zinc ferrite material comprises a main material, a functional additive and a correcting agent, wherein the main material comprises Fe₂O₃, Ni₂O₃, ZnO and CuO; the functional additive comprises a combination of any three or at least four of Mn₃O₄, TiO₂, Ta₂O₅, Co₂O₃ or Sm₂O₃; and the correcting agent comprises Fe₂O₃ and Ni₂O₃. In the present invention, an appropriate main formula correction process is used, and a suitable and inexpensive correcting agent and a functional additive are added to a ferrite material, such that the power loss of the prepared nickel-zinc ferrite material at 13.56 MHz can be significantly reduced.

### TECHNICAL FIELD

The present application relates to the technical field of soft magnetic ferrite, for example, a Ni—Zn ferrite material, a preparation method therefor and use thereof.

### BACKGROUND

Nickel-zinc (Ni—Zn) power ferrite has the characteristics of high saturation magnetic induction intensity (Bs), high resistivity (p), low loss (Pcv), etc., and is widely used in various components, such as power transformers, choke coils, pulse broadband transformers, magnetic deflectors and sensors. In particular, magnetic cores for the switching power supply or transformers made of Ni—Zn power ferrite with the characteristics of high saturation magnetization, high resistivity and low loss has become an indispensable component in computers, communications, televisions, video recorders, office automation and other electronic devices.

High frequency is an important symbol of power electronics technology; increasing the working frequency can reduce the volume and weight of the transformer. Under the same magnetic flux density, doubling the frequency can reduce the cross-sectional area of the transformer magnetic core by half, and a typical example is that the volume of the 6.78 MHz, 75 W switching power supply is half of the volume of the 13.56 MHz, 75 W switching power supply, which can greatly save space and achieve the effective use of resources.

With the application of wide-bandgap materials such as the third-generation semiconductors SiC and GaN in transformers, the transistors in the transformer can work at MHz or higher frequencies to achieve more efficient power transmission and conversion, which can greatly promote the miniaturization, high frequency and energy saving of switching power supplies.

Correspondingly, as the core part of the transformer, the nickel-zinc ferrite magnetic core material also urgently needs to match the MHz-level working frequency band of the third-generation semiconductor material. If the optimal application frequency of the conventional power ferrite can be increased from hundreds of kHz to MHz, not only ultra-high efficiency small switching power supply can be developed in various fields of consumer equipment, improving the efficiency and quality of various electrical appliances, but also high-efficiency power supply with ultra-small volume that does not need heat dissipation devices can be developed in the field of military equipment, which can adapt to more complex environments, provide higher conversion efficiency, and greatly reduce the burden of equipment transportation.

More importantly, with the rapid development of new technologies such as new energy vehicles, wireless fast charging, and the Internet of Things, high-efficiency and high-density conversion and transmission of signals and energy are required, and other low-frequency interference information needs to be avoided, which especially need a Ni—Zn ferrite material that has ultra-low loss and ultra-high conversion efficiency in the 13.56 MHz frequency band to achieve.

CN105198396A disclosed a Ni—Cu—Zn ferrite material and a preparation method therefor; the formula is composed of 47-49 mol % Fe₂O₃, 15-22 mol % NiO, 25-30 mol % ZnO, 4-7 mol % CuO and 0.1-0.5 mol % Co₂O₃. The ferrite material has serious power loss at 13.56 MHz and is not suitable for practical applications.

CN109095915A disclosed a combined alternative method of In(Cd,Ga), Ni, Ti and Co ions for the preparation of high-performance Mn—Zn ferrite. To the selected main component, one or more of assistant components containing Ni, Ti and Co are added, one or more of assistant components containing In, Cd, and Ga elements are added, and one or more of assistant components containing Ca and Si elements are added. The method uses precious rare metals, and the high cost is not conducive to actual production.

### SUMMARY

The following is a summary of subject matter that is described in detail herein. This summary is not intended to be limiting as to the scope of the claims.

The present application provides a Ni—Zn ferrite material, a preparation method therefor and use thereof. A suitable correction process for the main formula is used in the present application, which can significantly reduce the power loss of the prepared nickel-zinc ferrite material at 13.56 MHz by adding the appropriate cheap corrector and functional additive to the ferrite material.

In a first aspect, the present application provides a Ni—Zn ferrite material. The Ni—Zn ferrite material includes a main material, a functional additive and a corrector, the main material includes Fe₂O₃, Ni₂O₃, ZnO and CuO, the functional additive includes any three or a combination of at least four of Mn₃O₄, TiO₂, Ta₂O₅, Co₂O₃ or Sm₂O₃, and the corrector includes Fe₂O₃ and Ni₂O₃.

In the present application, the raw materials and auxiliary additives in the nickel-zinc ferrite material are all common materials that are commercially available, and do not contain expensive rare metal oxides. The nickel-zinc ferrite material only uses a few common oxides such as Mn₃O₄, TiO₂, Ta₂O₅, or Co₂O₃ as additives, which has low cost, independent and controllable raw materials, and low risk; the material is optimized in the power loss at 13.56 MHz, and improved in the power conversion efficiency at 13.56 MHz, and has advantages of high permeability, high saturation flux density, and low loss.

In one embodiment, based on the molar amount of the main material being 100%, a molar fraction of Fe₂O₃ is 47.5-49.9%, for example, 47.5%, 47.8%, 48%, 49% or 49.9%.

In one embodiment, a molar fraction of Ni₂O₃ is 18.5-22.5%, for example, 18.5%, 19%, 19.5%, 20%, 21% or 22.5%.

In one embodiment, a molar fraction of ZnO is 21.5-25.5%, for example, 21.5%, 22%, 23%, 24% or 25.5%.

In one embodiment, a molar fraction of CuO is 3.5-7.5%, for example, 3.5%, 4%, 5%, 6% or 7.5%.

In one embodiment, based on the total mass of the main material after pre-sintering, an additive amount of Mn₃O₄ is 1000-1100 ppm, for example, 1000 ppm, 1020 ppm, 1050 ppm, 1080 ppm or 1100 ppm.

In one embodiment, an additive amount of TiO₂ is 0-150 ppm, for example, 0 ppm, 10 ppm, 20 ppm, 50 ppm, 100 ppm or 150 ppm.

In one embodiment, an additive amount of Ta₂O₅ is 300-500 ppm, for example, 300 ppm, 350 ppm, 400 ppm, 480 ppm or 500 ppm.

In one embodiment, an additive amount of Co₂O₃ is 1500-3500 ppm, for example, 1500 ppm, 1800 ppm, 2000 ppm, 2500 ppm or 3500 ppm.

In one embodiment, an additive amount of Sm₂O₃ is 500-1200 ppm, for example, 500 ppm, 600 ppm, 800 ppm, 1000 ppm or 1200 ppm.

In one embodiment, based on the total mass of the main material after pre-sintering, an additive amount of Fe₂O₃ is 1300-2100 ppm, for example, 1300 ppm, 1500 ppm, 1800 ppm, 2000 ppm or 2100 ppm.

In one embodiment, an additive amount of Ni₂O₃ is 1700-2300 ppm, for example, 1700 ppm, 1800 ppm, 2000 ppm, 2100 ppm or 2300 ppm.

In a second aspect, the present application provides a preparation method for the nickel-zinc ferrite material as described in the first aspect, and the preparation method includes the following steps:
(1) wet-mixing the main material to obtain a slurry, drying and then pre-sintering the slurry to obtain a powder material;
(2) mixing the functional additive, the corrector and the powder material, wet-grinding and then drying, adding a polyvinyl alcohol solution and subjecting to granulation treatment; and
(3) pressing a material obtained after the granulation treatment in step (2), and then subjecting the material to sintering treatment to obtain the nickel-zinc ferrite material.

In the related grinding process, neither the conventional grinding method nor the planetary ball milling in the present application can avoid the increase of Zr element components in the powder caused by zirconium ball abrasion, which changes the main formula, and the properties such as magnetic permeability, power loss, and temperature characteristics of the material are inconsistent with the expected design and are difficult to control. In the present application, the deviation of the main formula components caused by the relevant process is manually corrected by adding an appropriate amount of Fe₂O₃ and Ni₂O₃. By adopting an appropriate main formula, combining an appropriate grinding process, and adding a corresponding appropriate amount of the main-formula corrector, the loss of the prepared ferrite material at 13.56 MHz can be significantly reduced.

In one embodiment, the wet-mixing in step (1) incudes wet ball milling.

In one embodiment, zirconium balls used in the ball milling include a 1:1:1 combination of zirconium balls of Φ 6 mm, Φ 14 mm, Φ 22 mm.

The combination of steel balls in large, medium and small sizes can reduce the gap between zirconium balls during ball milling, which can not only effectively mix the raw materials evenly, but also concentrate the particle size distribution of raw materials, avoiding component segregation, and improving powder activity.

In one embodiment, the ball milling includes planetary ball milling.

In one embodiment, a ball-to-material ratio of the ball milling is 1:(2-4), for example, 1:2, 1:2.5, 1:3, 1:3.5 or 1:4.

The operation mode of planetary ball milling is carrying out the revolution of the turntable and the rotation of the tank in the opposite direction simultaneously, including the collision between the balls, the grinding between the ball and the tank, and the smashing of the ball falling from the high point to the low point, which can effectively grind the powder material of different particle sizes and different hardness; moreover, two type of zirconium balls with different mass are employed by a high material-to-ball ratio, the steel ball grinding can cover the entire tank during ball milling; in addition, the revolution and rotation directions can be optionally switched every 10 min, and in this way, the movement trajectories of the powder and the steel balls are not towards a single direction, and any part of the powder can be milled. Compared with the conventional grinding method of single-direction sand grinding or ball milling with a material-to-ball ratio of 1:2-3, the planetary ball milling with a high material-to-ball ratio can effectively grind the powder particles in a short time with a narrower and more uniform particle size distribution.

In one embodiment, the pre-sintering in step (1) is performed at a temperature of 850-980° C., for example, 850° C., 880° C., 900° C., 950° C. or 980° C.

In one embodiment, the pre-sintering is performed for a period of 2.5-3.5 h, for example, 2.5 h, 2.8 h, 3 h, 3.2 h or 3.5 h.

In one embodiment, cooling to room temperature with the furnace is performed after the pre-sintering.

In one embodiment, the wet-grinding in step (2) is performed for a period of 90-150 min, for example, 90 min, 100 min, 120 min, 140 min or 150 min.

In one embodiment, a mass concentration of the polyvinyl alcohol solution is 8-12 wt %, for example, 8 wt %, 9 wt %, 10 wt %, 11 wt % or 12 wt %.

In one embodiment, a sieving treatment is performed before the pressing in step (3).

In one embodiment, a screen mesh number of the sieving treatment is 40-100 mesh, for example, 40 mesh, 50 mesh, 60 mesh, 80 mesh or 100 mesh.

In one embodiment, a density of the material after the pressing is more than or equal to 3.0 g/cm³.

In one embodiment, the sintering treatment in step (3) is performed at a temperature of 1050-1150° C., for example, 1050° C., 1080° C., 1100° C., 1120° C. or 1150° C.

In one embodiment, the sintering treatment is performed for a period of 3-5 h, for example, 3 h, 3.5 h, 4 h, 4.5 h or 5 h.

In a third aspect, the present application provides use of the nickel-zinc ferrite as described in the first aspect, and the nickel-zinc ferrite material is used in the technical fields of new energy vehicles, wireless charging, and the Internet of Things at 13.56 MHz.

Compared with the prior art, the present application has the following beneficial effects.
(1) The present application uses a suitable main-formula correction process, which can significantly reduce the power loss of the prepared nickel-zinc ferrite material at 13.56 MHz by adding an appropriate corrector to the ferrite material.
(2) The nickel-zinc ferrite in the present application has an initial magnetic permeability of the range of 100±25%, a saturation magnetic flux density at 25° C. of more than or equal to 420 mT, and a saturation magnetic flux density at 100° C. of more than or equal to 360 mT; under the condition of 13.56 MHz, a magnetic core loss at 30 mT/25° C. can reach 346 kW/m³ or less, a magnetic core loss at 20 mT/25° C. can reach 279 kW/m³ or less, a magnetic core loss at 30 mT/100° C. can reach 436 kW/m³ or less, and a magnetic core loss at 20 mT/100° C. can reach 388 kW/m³ or less.

Other aspects will be appreciated upon reading and understanding the detailed description.

### DETAILED DESCRIPTION

The technical solutions of the present application are further described below in terms of specific embodiments. It should be clear to those skilled in the art that the embodiments are merely used for a better understanding of the present application and should not be regarded as a specific limitation to the present application.

### Example 1

This example provides a nickel-zinc ferrite material, and the main material of the nickel-zinc ferrite material is composed of 23.5 mol % ZnO, 49.5 mol % Fe₂O₃, 20.5 mol % Ni₂O₃, and 6.5 mol % CuO. The preparation method of the nickel-zinc ferrite material is as follows:
(1) the four raw materials of Fe₂O₃, Ni₂O₃, ZnO, and CuO were weighed and mixed by the above ratio, and then subjected to wet ball milling, wherein zirconium balls of Φ 6 mm, Φ 14 mm and Φ 22 mm were combined by 1:1:1 and a material-to-ball ratio was 1:3, to obtain a slurry; the slurry was dried, pre-sintered at 950° C. with heat preserved for 3 h in air atmosphere, and cooled to room temperature with the furnace to obtain a powder material;
(2) auxiliary functional additives Mn₃O₄, TiO₂, Ta₂O₅, Co₂O₃ and main formula correctors Fe₂O₃ and Ni₂O₃ of analytical pure were weighed as per the mass ratio relative to the powder material obtained after the pre-sintering in step (3), and added to the powder material to obtain a doped powder, wherein the doped ratio was based on the mass of the weighed powder material obtained in step (3): 1050 ppm Mn₃O₄, 100 ppm TiO₂, 400 ppm Ta₂O₅, 2500 ppm Co₂O₃, 1700 ppm Fe₂O₃, and 2000 ppm Ni₂O₃, and the obtained material was placed in a planetary ball mill and subjected to wet ball milling for 120 min, wherein zirconium balls of Φ 4 mm and Φ 5 mm were combined by 1:1 and a material-to-ball ratio was 1:7, to obtain a slurry; the slurry was dried and added with a 10 wt % polyvinyl alcohol (PVA) solution, mixed in a mortar and pre-pressed into a round pancake shape with a press, so that the polyvinyl alcohol (PVA) solution was fully mixed with the dried powder; and
(3) the obtained powder was sieved through a 80-mesh screen and then pressed into a solid annular green part with a density of more than or equal to 3.0 g/cm³; the obtained green part was sintered in a bell-type air sintering furnace at a sintering temperature of 1040° C. with heat preserved for 4 h to obtain the nickel-zinc ferrite material.

### Example 2

This example is only different from Example 1 where 49 mol % Fe₂O₃, 22.5 mol % Ni₂O₃ and 5 mol % CuO were used. Because the change of Fe₂O₃ and ZnO content in the main formula can directly affect the temperature characteristics of the material, the best performance temperature range of the material will shift, and in order to make the best performance temperature range always fall within the range of 25-100° C., the doping amount of Co₂O₃ additive with the same modification effect needs to be adjusted according to the example. Therefore, the additive amount of cobalt was changed to 2500 ppm, and other conditions and parameters were exactly the same as those in Example 1.

### Example 3

This example is only different from Example 1 where 47.5 mol % Fe₂O₃, 22.0 mol % Ni₂O₃ and 7 mol % CuO were used. Because the change of Fe₂O₃ and ZnO content in the main formula can directly affect the temperature characteristics of the material, the best performance temperature range of the material will shift, and in order to make the best performance temperature range always fall within the range of 25-100° C., the doping amount of Co₂O₃ additive with the same modification effect needs to be adjusted according to the example. Therefore, the additive amount of cobalt was changed to 1500 ppm, and other conditions and parameters were exactly the same as those in Example 1.

### Example 4

This example is only different from Example 1 where 49.5 mol % Fe₂O₃, 18.6 mol % Ni₂O₃, 25.5 mol % ZnO and 6.4 mol % CuO were used. Because the change of Fe₂O₃ and ZnO content in the main formula can directly affect the temperature characteristics of the material, the best performance temperature range of the material will shift, and in order to make the best performance temperature range always fall within the range of 25-100° C., the doping amount of Co₂O₃ additive with the same modification effect needs to be adjusted according to the example. Therefore, the additive amount of cobalt was changed to 3000 ppm, and other conditions and parameters were exactly the same as those in Example 1.

### Example 5

This example is only different from Example 1 where 49.9 mol % Fe₂O₃, 22.5 mol % Ni₂O₃, 21.5 mol % ZnO and 6.1 mol % CuO were used. Because the change of Fe₂O₃ and ZnO content in the main formula can directly affect the temperature characteristics of the material, the best performance temperature range of the material will shift, and in order to make the best performance temperature range always fall within the range of 25-100° C., the doping amount of Co₂O₃ additive with the same modification effect needs to be adjusted according to the example. Therefore, the additive amount of cobalt was changed to 2000 ppm, and other conditions and parameters were exactly the same as those in Example 1.

### Example 6

This example is different from Example 2 only in that the wet ball milling in step (2) was performed for a period of 90 min, the abrasion and iron loss of zirconium balls were less than those of Example 2, and the doped contents of main formula correctors Fe₂O₃ and Ni₂O₃ were 1300 ppm and 1700 ppm, respectively, and other conditions and parameters were exactly the same as those in Example 1.

### Example 7

This example is different from Example 2 only in that the wet ball milling in step (2) was performed for a period of 150 min, the abrasion and iron loss of zirconium balls were less than those of Example 2, and the doped contents of main formula correctors Fe₂O₃ and Ni₂O₃ were 2100 ppm and 2300 ppm, respectively, and other conditions and parameters were exactly the same as those in Example 1.

### Example 8

This example is different from Example 2 only in that the wet ball milling in step (2) was replaced by conventional sand milling, and other conditions and parameters were exactly the same as those in Example 1.

### Comparative Example 1

This comparative example is different from Example 2 only in that no corrector was added, and other conditions and parameters were exactly the same as those in Example 1.

### Comparative Example 2

This comparative example is different from Example 2 only in that corrector Fe₂O₃ was added alone, and other conditions and parameters were exactly the same as those in Example 1.

### Comparative Example 3

This comparative example is different from Example 2 only in that corrector Ni₂O₃ was added alone, and other conditions and parameters were exactly the same as those in Example 1.

### Comparative Example 4

This comparative example is different from Example 2 only in that no functional additive was added, and other conditions and parameters were exactly the same as those in Example 1.

### Comparative Example 5

This comparative example is different from Example 2 only in that merely two functional additives Mn₃O₄ and Co₂O₃ were added and other conditions and parameters were exactly the same as those in Example 1.

### Performance Test

The samples obtained in Examples 1-7 and Comparative Examples 1-2 were subjected to test for initial magnetic permeability at 1 KHz/0.25 V, and magnetic flux density at 25° C. and 100° C., and Japanese Iwatsu SY8218 B-H analyzer was used to test the unit volume loss Pcv, and then samples obtained in Example 8 and Comparative Examples 1-5 were selectively subjected to tests for initial magnetic permeability, and magnetic core loss at 30 mT. The test results are shown in Table 1.

TABLE 1

| | Initial | Magnetic flux | | Magnetic core loss at 13.56 MHz (kW/m³) | | | |
|---|---|---|---|---|---|---|---|
| | magnetic | density (mT) | | 30 mT/ | 20 mT/ | 30 mT/ | 20 mT/ |
| | permeability | 25° C. | 100° C. | 25° C. | 25° C. | 100° C. | 100° C. |
| Example 1 | 101 | 430 | 375 | 310 | 265 | 415 | 374 |
| Example 2 | 85 | 445 | 383 | 336 | 275 | 428 | 383 |
| Example 3 | 90 | 440 | 380 | 320 | 271 | 421 | 380 |
| Example 4 | 110 | 420 | 365 | 302 | 260 | 410 | 366 |
| Example 5 | 79 | 449 | 390 | 346 | 279 | 436 | 388 |
| Example 6 | 100 | 440 | 380 | 316 | 265 | 419 | 373 |
| Example 7 | 88 | 435 | 373 | 335 | 272 | 426 | 384 |
| Example 8 | 72 | 420 | 352 | 1235 | 1162 | 1426 | 1307 |
| Comparative | 96 | 376 | 344 | 581 | 690 | 602 | 746 |
| Example 1 | | | | | | | |
| Comparative | 148 | 388 | 329 | 604 | 633 | 667 | 705 |
| Example 2 | | | | | | | |
| Comparative | 88 | 399 | 351 | 652 | 620 | 618 | 731 |
| Example 3 | | | | | | | |
| Comparative | 56 | 390 | 358 | 670 | 644 | 625 | 729 |
| Example 4 | | | | | | | |
| Comparative | 63 | 395 | 361 | 678 | 699 | 705 | 811 |
| Example 5 | | | | | | | |

As can be seen from Table 1, the following can be obtained from Examples 1-7: the nickel-zinc ferrite in the present application has an initial magnetic permeability of the range of 100±25%, a saturation magnetic flux density at 25° C. of more than or equal to 420 mT, and a saturation magnetic flux density at 100° C. of more than or equal to 360 mT; under the condition of 13.56 MHz, a magnetic core loss at 30 mT/25° C. can reach 346 kW/m³ or less, a magnetic core loss at 20 mT/25° C. can reach 279 kW/m³ or less, a magnetic core loss at 30 mT/100° C. can reach 436 kW/m³ or less, and a magnetic core loss at 20 mT/100° C. can reach 388 kW/m³ or less.

As can be seen from the comparison of Example 1 and Comparative Examples 6-7, in the present application, the additive amount of the corrector can be adjusted by the period of ball milling, and the method is flexible and controllable with an obvious effect.

As can be seen from the comparison of Example 2 and Example 8, in the present application, the grinding method has an obvious influence on the obtained nickel-zinc ferrite during the preparation process of the nickel-zinc ferrite. If the ball milling method adopts conventional sand grinding instead of planetary ball milling, there are obvious deficiencies in both loss and magnetic permeability performance. The planetary ball milling with high material-to-ball ratio adopted in the present application can effectively grind the powder particles and the particle size distribution can be narrower and more uniform in a short time.

As can be seen from the comparison of Example 2 and Comparative Examples 1-3, in absence of corrector Fe₂O₃ and/or Ni₂O₃, the loss and temperature performance of the prepared nickel-zinc ferrite material changed, and the loss at 25° C. and 100° C. increases. The present application adopts a suitable main formula correction process, which can significantly reduce the power loss at 13.56 MHz.

As can be seen from the comparison of Example 2 and Comparative Examples 4-5, in the present application, a variety of functional additives are appropriately added to the nickel-zinc ferrite material, in which the addition of an appropriate amount of Mn₃O₄ can greatly increase the resistivity and improve the power consumption characteristics; the addition of an appropriate amount of TiO₂ can inhibit the participation of Fe²⁺ in the conductive mechanism, reduce the material loss, and reduce the sintering temperature without promoting the growth of grains, thereby improving the comprehensive magnetic properties; the addition of a small amount of Co₂O₃ can improve the frequency and loss characteristics of the material, in which Co²⁺ can form uniaxial anisotropy, resulting in a deep energy valley and freezing the domain wall, thereby increasing the resonance frequency of the domain wall; the addition of an appropriate amount of Sm₂O₃ can effectively control the magnetostriction coefficient of the material; and the addition of an appropriate amount of Ta₂O₅ can make the temperature curve more flat.

The applicant declares that the above is only specific examples of the present application, but the present application is not limited to the above examples. Those skilled in the art should understand that any change or replacement that can be easily thought of by those skilled in the art within the technical scope disclosed in the present application shall fall within the protection scope and disclosure scope of the present application.

1. A Ni—Zn ferrite material, which comprises a main material, a functional additive and a corrector, and the main material comprises Fe₂O₃, Ni₂O₃, ZnO and CuO, the functional additive comprises any three or a combination of at least four of Mn₃O₄, TiO₂, Ta₂O₅, Co₂O₃ or Sm₂O₃, and the corrector comprises Fe₂O₃ and Ni₂O₃.

2. The Ni—Zn ferrite material according to claim 1, wherein based on the molar amount of the main material being 100%, a molar fraction of Fe₂O₃ is 47.5-49.9%.

3. The Ni—Zn ferrite material according to claim 1, wherein based on the molar amount of the main material being 100%, a molar fraction of Ni₂O₃ is 18.5-22.5%.

4. The Ni—Zn ferrite material according to claim 1, wherein based on the molar amount of the main material being 100%, a molar fraction of ZnO is 21.5-25.5%.

5. The Ni—Zn ferrite material according to claim 1, wherein based on the molar amount of the main material being 100%, a molar fraction of CuO is 3.5-7.5%.

6. The Ni—Zn ferrite material according to claim 1, wherein based on the total mass of the main material after pre-sintering, an additive amount of Mn₃O₄ is 1000-1100 ppm.

7. The Ni—Zn ferrite material according to claim 1, wherein based on the total mass of the main material after pre-sintering, an additive amount of Fe₂O₃ is 1300-2100 ppm.

8. A preparation method for the Ni—Zn ferrite material according to claim 1, which comprises the following steps:
(1) wet-mixing the main material to obtain a slurry, drying and then pre-sintering the slurry to obtain a powder material;
(2) mixing the functional additive, the corrector and the powder material, wet-grinding and then drying the same, adding a polyvinyl alcohol solution and subjecting to granulation treatment; and
(3) pressing a material obtained from the granulation treatment in step (2), and then subjecting the material to sintering treatment to obtain the nickel-zinc ferrite material.

9. The preparation method according to claim 8, wherein the wet-mixing in step (1) comprises wet ball milling.

10. The preparation method according to claim 9, wherein zirconium balls used in the wet ball milling comprise a 1:1:1 combination of zirconium balls of Φ 6 mm, Φ 14 mm, Φ 22 mm;
optionally, the wet ball milling comprises planetary ball milling;
optionally, a ball-to-material ratio of the wet ball milling is 1:(2-4).

11. The preparation method according to claim 8, wherein the pre-sintering in step (1) is performed at a temperature of 850-980° C.;
optionally, the pre-sintering is performed for a period of 2.5-3.5 h;
optionally, cooling to room temperature with furnace is performed after the pre-sintering.

12. The preparation method according to claim 8, wherein the wet-grinding in step (2) is performed for a period of 90-150 min;
optionally, a mass concentration of the polyvinyl alcohol solution is 8-12 wt %.

13. The preparation method according to claim 8, wherein a sieving treatment is performed before the pressing in step (3);
optionally, a screen mesh number of the sieving treatment is 40-100 mesh;
optionally, a density of the material after the pressing is more than or equal to 3.0 g/cm³.

14. The preparation method according to claim 8, wherein the sintering treatment is performed at a temperature of 1050-1150° C.;
optionally, the sintering treatment is performed for a period of 3-5 h.

15. (canceled)

16. The Ni—Zn ferrite material according to claim 6, wherein an additive amount of TiO2 is 0-150 ppm.

17. The Ni—Zn ferrite material according to claim 6, wherein an additive amount of Ta₂O₅ is 300-500 ppm.

18. The Ni—Zn ferrite material according to claim 6, wherein an additive amount of Co₂O₃ is 1500-3500 ppm.

19. The Ni—Zn ferrite material according to claim 6, wherein an additive amount of Sm₂O₃ is 500-1200 ppm.

20. The Ni—Zn ferrite material according to claim 7, wherein an additive amount of Ni₂O₃ is 1700-2300 ppm

21. A preparation method for magnetic cores, comprising using the Ni—Zn ferrite material according to claim 1.
